(19) United States
(12) Patent Application Publication
(10) Pub. No.: US 2010/0230999 A1
(43) Pub. Date: Sep. 16, 2010

(54) Ultra-Light Tent Trailer

(76) Inventor: Michael William Setzer, Camano Island, WA (US)

Correspondence Address: Michael Setzer, 2875 S East Camano Drive, Camano Island, WA, 98282, US

(21) Appl. No.: 12/723,636

(22) Filed: Mar. 13, 2010

Related U.S. Application Data
(60) Provisional application No. 61/209,979, filed on Mar. 13, 2009.

(51) Int. Cl. B60P 3/355

(52) U.S. Cl. 296/173

(57) ABSTRACT

The present invention is an ultra-light, aerodynamic, and towable recreational vehicle with integral self-inflating tent and accessory storage compartments. With motorcycles or a lightweight car as the intended towing vehicle, the ultra-light tent trailer includes a lightweight welded tubular steel frame, independent adjustable suspension, and composite aerodynamic body components to support the mechanicals of the tent trailer. A swingarm and crossbar assembly may support the floor of the tent component and may be controlled by a motor system. The motors may be remotely activated to open the tent trailer from a stowed configuration to an open configuration, and an inflation unit may also be remotely activated to inflate an inflatable tent. Thus, the push-button convenience makes this an incomparably quick and easy method of establishing a camp shelter. The aerodynamic features combined with the lightweight assembly reduce fuel consumption and present an efficient and stylish alternative over the prior art.

### CROSS REFERENCE TO RELATED APPLICATIONS

The present application claims the benefit of U.S. Provisional Application No. 61/209,979 filed Mar. 13, 2009, which is incorporated herein by reference.

### FIELD OF THE INVENTION

The present invention relates to lightweight mobile camping shelters and specifically to tent trailers that can be towed by low-powered and lightweight vehicles including hybrid vehicles, motorcycles and sub-compact vehicles.

### BACKGROUND OF THE INVENTION

The towable tent trailer has been in existence for many years and is being manufactured today in much the same configuration it was over 30 years ago. These trailers consist of substantial steel frames with aluminum clad wood boxes housing the interior of the trailer and having a top section that elevates through extension of telescopic corner supports. These conventional tent trailers are typically comprised of tables, settees, counters, sinks, ranges, fold out beds and other comforts and conveniences. These trailers require significant effort to set up when establishing a campsite and they also require a towing vehicle with a robust drive train and suspension system in order to safely navigate the highways.

Motorcycle tent trailers have become popular in more recent years with the advent of larger, more comfortable, more powerful cruising motorcycles. These tent trailers are typically aluminum clad boxes set on heavy-duty steel frames similar to the aforementioned tent trailers but are much lighter due to the resultant scale configured for motorcycle towing. However, these conventional motorcycle tent trailers still have the look and feel of the old tent trailer technology and involve substantial procedures in order to set up the camper. In light of the towing limitations of motorcycles, one lightweight alternative has been motorcycle trailers with composite bodies. These systems are severely limited because no tent is included with these body configurations although they do offer storage for items during long-term cruising.

Additionally, as non-renewable resources have become increasingly scarce, consumers have begun reevaluating their needs for large and inefficient vehicles. Indeed, consumers have responded enthusiastically to the efforts by automakers to produce more energy-efficient vehicles by purchasing these new vehicles in record numbers. Further, new emissions standards suggest that more consumers will be driving such lightweight vehicles in the near future. Although the towing capacity of these new vehicles may restrict the comforts and conveniences of traditional tent trailers and campers, consumers do not want to leave behind their conveniences entirely behind.

The present invention addresses these issues for the adventurous, energy-conscious individuals that would like some of the traditional comforts, the technological conveniences and the overall efficiency of these trailer systems. It also addresses the needs of the cruising motorcyclist that wants a tent trailer with as much towability, convenience, style and comfort as possible.

### SUMMARY OF THE INVENTION

This summary is provided to introduce (in a simplified form) a selection of concepts that are further described below in the Detailed Description. This summary is not intended to identify key features of the claimed subject matter, nor is it intended to be used as an aid in determining the scope of the claimed subject matter.

In overcoming the above disadvantages associated with traditional resource-intensive camping vehicles, a lightweight tent camper system and apparatus are described herein.

The present invention may include a lightweight tent camper, comprising a frame member; a body member attached to the frame member providing a storage area; a first swing arm member attached to the frame member with a first hinge member; a second swing arm member attached to the frame member with a second hinge member; a first panel attached to the first swing arm member; a second panel attached to the second swing arm member, wherein the first panel and the second panel enclose the storage area when the first swing arm member and the second swing arm member are in a first closed position; at least one actuator member attached to the frame member for rotating the first swing arm and the second swing arm from the first closed position to a second open position; and a tent attached to the first swing arm member and the second swing arm member.

In accordance with another aspect of the present invention, the actuator member automatically rotates the first swing arm member and the second swing arm member from the first closed position to the second open position in response to a remote trigger.

In accordance with another aspect of the present invention, the first swing arm member is further hingably coupled to a crossbar member, and the second swing arm member is further hingably coupled to the crossbar member.

In accordance with another aspect of the present invention, the crossbar member comprises: a first crossbar portion hingably connected to the first swing arm member; a second crossbar portion hingably connected to the second swing arm member; and a central crossbar portion slidably coupled with the first crossbar portion and the second crossbar portion.

In accordance with another aspect of the present invention, the crossbar member telescopically changes length when the at least one actuator member rotates the first swing arm and the second swing arm from the first closed position to the second open position.

In accordance with another aspect of the present invention, the tent further comprises a tarpaulin floor tensioned by the first swing arm member and the second swing arm member.

In accordance with another aspect of the present invention, the tent further comprises a paneled floor.

In accordance with another aspect of the present invention, the body member comprises an aerodynamic composite shell.

In accordance with another aspect of the present invention, the composite shell is constructed of a material selected from the group consisting of carbon graphite molded panels, fiberglass molded panels, and vacuum formed plastic compositions.

In accordance with another aspect of the present invention, the frame member further comprises: at least one axle; at least one pair of wheel and tire assemblies associated with the at least one axle; and at least one trailer attachment member for attaching the lightweight tent camper to a towing vehicle.

In accordance with another aspect of the present invention, the lightweight tent camper is a trailer capable of being towed by a motorcycle or small car.

In accordance with another aspect of the present invention, the tent is an inflatable tent, and wherein the lightweight tent camper further comprises: an inflation member attached to the frame member for inflating the inflatable tent.

In accordance with another aspect of the present invention, the inflation member automatically inflates the inflatable tent while the actuator member is rotating the first swing arm member and the second swing arm member from the first closed position to the second open position in response to a remote trigger.

In accordance with another aspect of the present invention, the inflation member is selected from the group consisting of compressed air, a fan blower, and an air compressor.

In accordance with another aspect of the present invention, the tent is erected using tent poles.

In accordance with another aspect of the present invention, the tent is configured in a tent configuration selected from the group consisting of a dome configuration, barrel configuration, and teepee configuration.

In accordance with another aspect of the present invention, the actuator member is selected from the group consisting of an electric motor, an actuator, pneumatics, hydraulics, a gear motor, and a spring-loaded mechanism.

In accordance with another aspect of the present invention, the tent camper is adaptable to attach to a cargo portion of a truck.

The present invention may further include a lightweight tent camper system, comprising: a frame member; a body member attached to the frame member providing a storage area; a first swing arm member attached to the frame member with a first hinge member; a second swing arm member attached to the frame member with a second hinge member; a first panel attached to the first swing arm member; a second panel attached to the second swing arm member, wherein the first panel and the second panel enclose the storage area when the first swing arm member and the second swing arm member are in a first closed position; at least one actuator member attached to the frame member for rotating the first swing arm and the second swing arm from the first closed position to a second open position; and a tent attached to the first swing arm member and the second swing arm member.

### BRIEF DESCRIPTION OF THE DRAWINGS

Preferred and alternative examples of the present invention are described in detail below by way of example and with reference to the drawings, in which:

FIG. 1 illustrates an isometric view of a tent trailer in a stowed configuration in accordance with an embodiment of the present invention;

FIG. 2 illustrates an isometric front view of a tent trailer in an opened configuration in accordance with an embodiment of the present invention;

FIG. 3 illustrates a side view of a tent trailer in an opened configuration in accordance with an embodiment of the present invention;

FIG. 4 illustrates an isometric rear view of a tent trailer in an opened configuration in accordance with an embodiment of the present invention;

FIG. 5 illustrates an isometric front view of a tent trailer in an opened configuration in accordance with an embodiment of the present invention;

FIG. 6 illustrates an isometric view of the frame of a tent trailer in accordance with an embodiment of the present invention;

FIG. 7 illustrates a detail view of a motor and linkage in a tent trailer in accordance with an embodiment of the present invention;

FIG. 8 illustrates a tent camper in the cargo portion of a vehicle in a stowed configuration in accordance with an embodiment of the present invention;

FIG. 9 illustrates a tent camper in the cargo portion of a vehicle in a opened configuration in accordance with an embodiment of the present invention;

FIG. 10A illustrates a detailed view of a tent trailer in a opened configuration in accordance with an embodiment of the present invention;

FIG. 10B illustrates a detailed view of a tent trailer in an intermediate configuration in accordance with an embodiment of the present invention;

FIG. 10C illustrates a detailed view of a tent trailer in a closed configuration in accordance with an embodiment of the present invention;

FIG. 11 illustrates an isometric view of an alternate frame configuration of a tent trailer in accordance with an embodiment of the present invention;

FIG. 12 illustrates block diagram view of a tent trailer in accordance with an embodiment of the present invention;

FIG. 13 illustrates an isometric view of a panel floor configuration in a tent trailer in accordance with an embodiment of the present invention; and

FIG. 14 illustrates an isometric view of a tarpaulin floor configuration in a tent trailer in accordance with an embodiment of the present invention.

### DETAILED DESCRIPTION

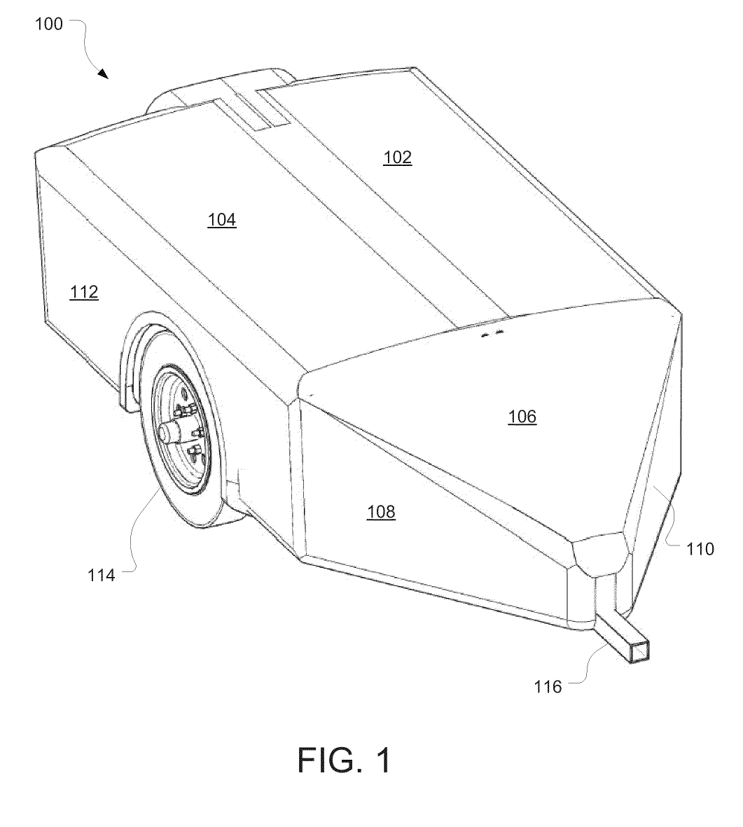

In accordance with an exemplary embodiment of the present invention, FIG. 1 illustrates an isometric view of a tent trailer 100 in a stowed configuration. In this stowed configuration, tent trailer 100 presents an aerodynamic profile for efficient towing. Top panels 102 and 104 form the roof of the tent trailer 100 in the stowed configuration and also enclose the storage area created by the body panels 112. Additionally, panels 106, 108, and 110 enclose a smaller storage compartment in the front of the trailer 100. The tent trailer 100 rides on a wheel and tire assembly 114, and may be towed by attaching any standard towing hitch to the towing member 116.

In one embodiment, the body panels 102, 104, 106, 108, 110, and 112 may be made out of carbon graphite molded panels, fiberglass molded panels, and vacuum formed plastic compositions. In another embodiment, the body panels may be made out of any stamped or formed metal or alloy.

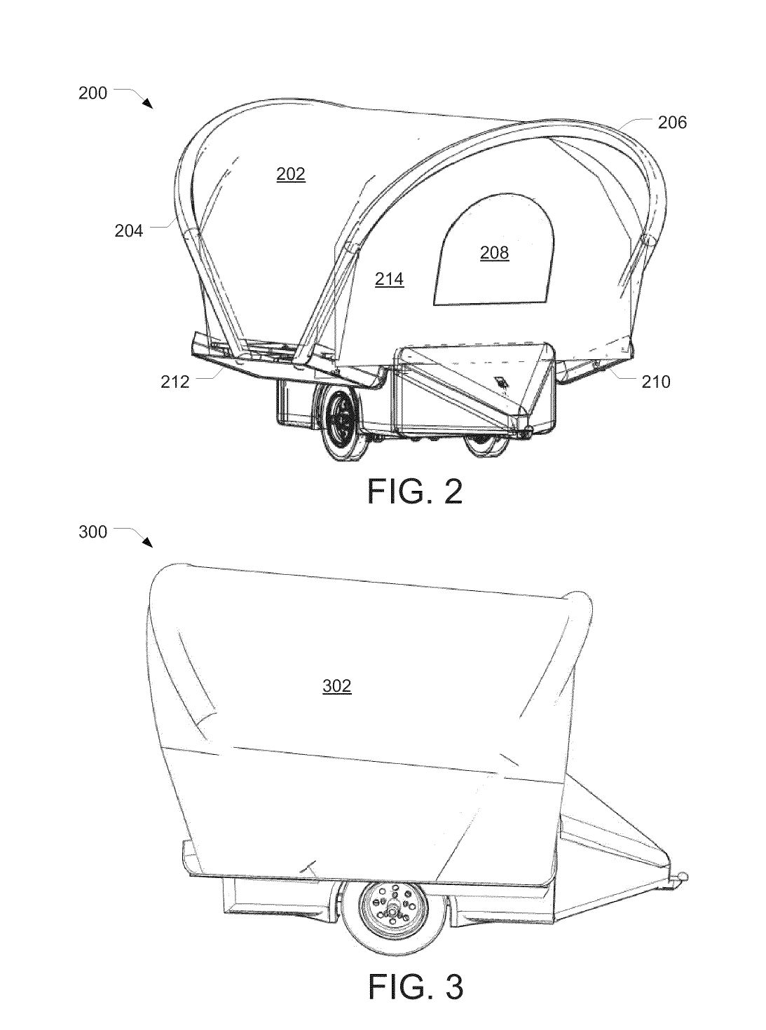

FIG. 2 illustrates an isometric front view of a tent trailer 200 in an opened configuration in accordance with an embodiment of the present invention. In this example, top panels 210 and 212 (e.g., “wings”) are in an open position, allowing the tent to be erected to provide shelter. The tent in this tent trailer 200 is an example of a barrel configuration, with upper panel 202 providing the walls and roof of the tent. Air chambers 204 and 206 are inflated to provide structure and support for the tent top panel 202 and the tent front panel 214. In this example, tent front panel 214 may include a zippered window 208.

In another embodiment, top panel 202 and front panel 214 may include any number of windows or doors. Further, traditional interlocking plastic, aluminum, steel, or graphite tent poles may be used in lieu of or in addition to air chambers 204 and 206.

FIG. 3 illustrates a side view of a tent trailer 300 in an opened configuration in accordance with an embodiment of the present invention. The side/top panel 302 corresponds to the top panel 202 in FIG. 2.

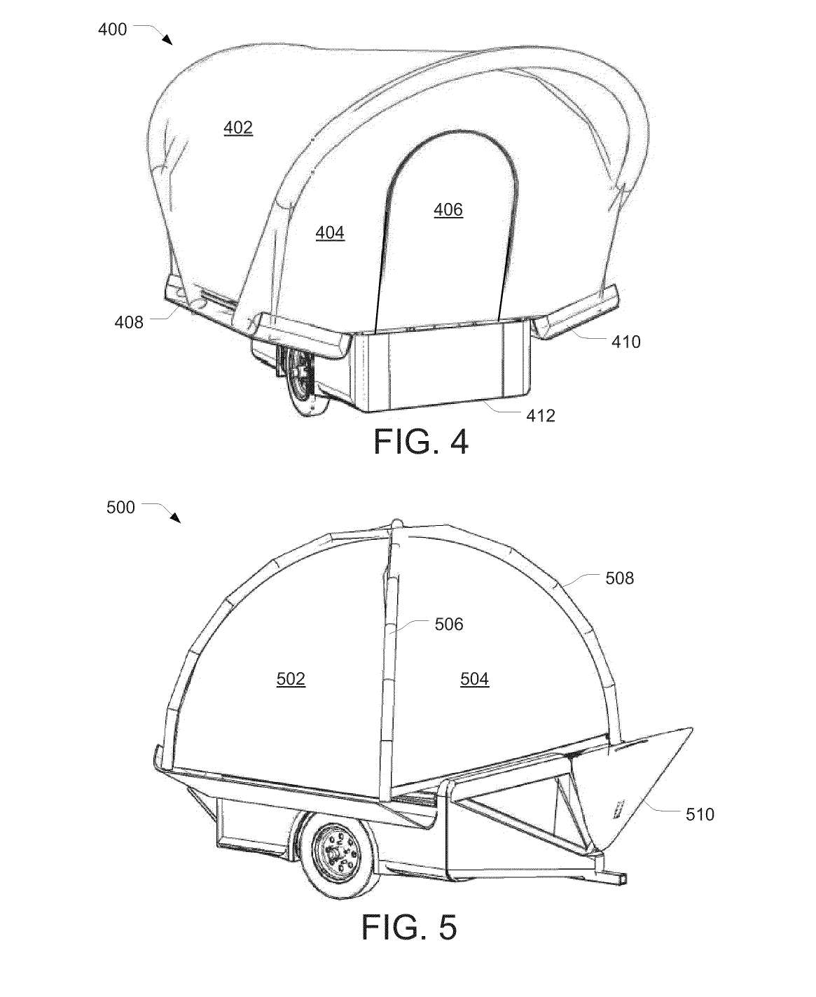

FIG. 4 illustrates an isometric rear view of a tent trailer 400 in an opened configuration in accordance with an embodiment of the present invention. This tent trailer 400 corresponds to the tent trailer 200 and 300 seen in FIGS. 2 and 3. The side panel 402 corresponds with the side/top panels 202 and 302 in FIGS. 2 and 3. Further, tent body wings 408 and 410 are shown in an open position, providing a base for the tent portion of the tent trailer 400. Rear gate 412 allows a user access to the storage portion of the tent trailer 400 when the tent trailer 400 is in a closed or open position. Additionally, when in the open position 400, a user may enter the tent via door 406 in rear panel 404.

FIG. 5 illustrates an isometric front view of a tent trailer 500 in an opened configuration in accordance with an embodiment of the present invention. In this embodiment, the tent may be configured in a dome configuration. In alternate embodiments, the tent may be configured in a teepee configuration or any configuration known in the art. The dome tent in the tent trailer 500 is supported by inflatable cells 506 and 508. Front panel 504 and side panel 502 can be seen in this configuration. Further, the storage area cover 510 is shown in an open configuration, allowing a user to access the mechanicals of the tent trailer 500 or to access stored materials.

In an alternate embodiment, solid tent poles may be used in lieu or in addition to inflatable chambers 506 and 508. In another embodiment, the tent may be configured in any manner as is known in the art.

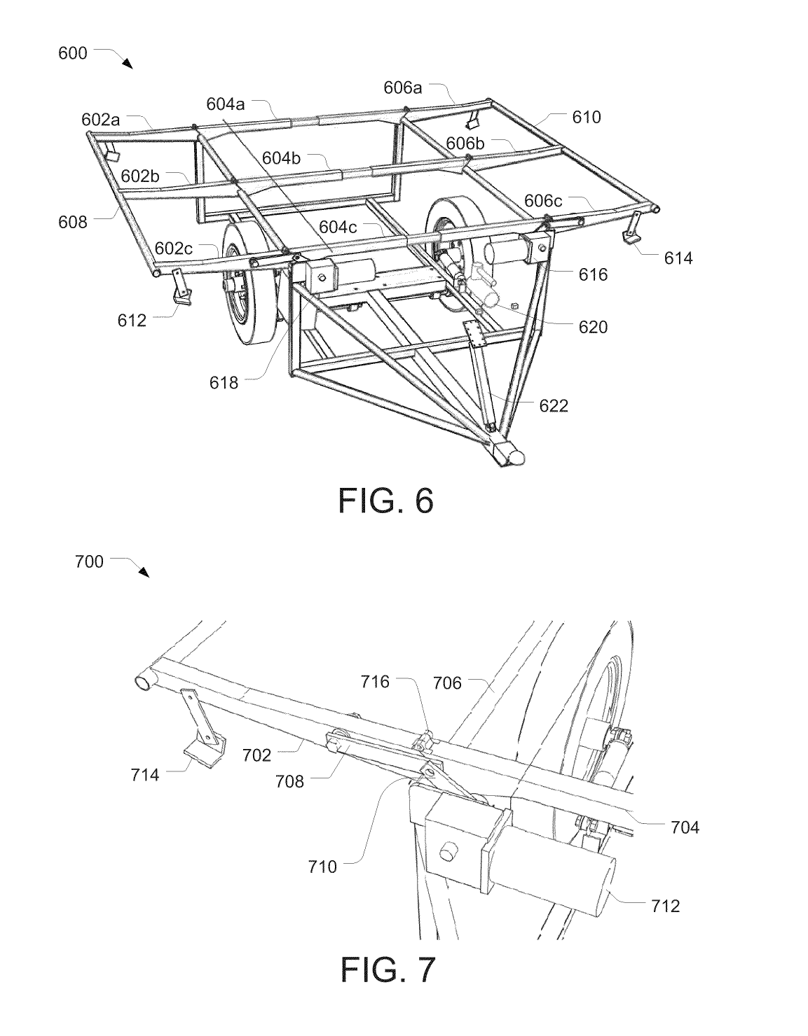

FIG. 6 illustrates an isometric view of a tent trailer frame 600 in accordance with an embodiment of the present invention. The frame 600 may be constructed of a light gauge fully welded steel frame fabricated in a similar manner used to fabricate light and ultra-light aircraft steel tubular frames. Alternatively, the frame 600 may be constructed using any techniques conventional to constructing frames and may be constructed using a variety of materials such as, but not limited to, aluminum, carbon fiber, or any metal or composite known in the art. In one embodiment, frame 600 may comprise at least one axle and an associated wheel and tire assembly. Frame 600 may additionally comprise an independent air ride suspension system which allows for adjustments to the ride of the trailer based on the relative load introduced by variable load factors. In another embodiment frame 600 may include any type of stabilizers, levelers, or jacks to support the frame 600 in an open configuration.

Mounted to the frame are swingarms 602a-c and 606a-b, and crossbars 604a-c. End rails 608 and 610 provide structural support for the wings (collectively formed by swingarms 602a-c and end rail 608 on the left side and by swingarms 606a-c and end rail 610 on the right side of the frame 600). Additionally, mounting brackets 612 and 614 attach the body panels (e.g., 408 and 410 of FIG. 4) to the wings. Motors 616 and 618 control movement of the wings when activated from a closed to open position and vice versa. Inflation member 620 may inflate and deflate the air cells in the tent when directed. Hinge 622 provides a hidden hinge for mounting the storage area cover 510 of FIG. 5.

In one embodiment, one or more motors may be used in lieu of motors 616 and 618. In an alternate embodiment, the motors may be any articulating means including, but not limited to, a gear motor, an electric motor, an actuator, pneumatics, hydraulics, or a spring-loaded assist. Further, an actuator member may be omitted entirely in a further embodiment.

In another embodiment, the inflation member 620 may include, but is not limited to, a fan blower, an air compressor, or compressed air. Further, the inflation member may include a manual pump used as a backup for or in addition to the inflation member 620. In another embodiment, the inflation member 620 may be configured to inflate an air mattress or other inflatable object (e.g., an inflatable raft or beach ball).

In an alternate embodiment, the hinge 622 may be powered by a motor or alternate actuator means (not shown) for automatic opening and closing of a storage area cover (e.g., 510). In another embodiment, the hinge 622 motor, the inflation member 620, and the motors 616 and 618 may be activated by a remote control mechanism or by a control unit incorporated into the tent trailer configuration.

FIG. 7 illustrates a detail view 700 of the motor and linkage in a tent trailer in accordance with an embodiment of the present invention. This detail view 700 shows components corresponding to the swingarms (e.g., 602a-c and 606a-c), crossbars 604a-c, and motors 616 and 618 in FIG. 6. In the detail view 700, motor 712 is mounted to the frame of the tent trailer. Motor 712 may be any articulating means as described above in relation to motors 616 and 618. Further, motor 712 is connected to linkage 710 and 708 which in turn are connected to swingarm 702. Thus, when motor 712 is activated, the torque generated is transferred to the linkage 710 and 708 which moves the swingarm from an open position to a closed position and back. In this detail view 700, the linkage moves clockwise to close the swingarm 702 and counter-clockwise to move the swingarm 702 to an open position. As will be explained in more detail shortly, swingarm 702 is mounted on rotating tube component 706 and is coupled with the crossbar 704 via hinge mechanism 716. Detail view 700 additionally shows the mounting bracket 714 which connects a body panel (e.g., 408 and 410) to the swing arm 714 while allowing the body panel to move into optimized positions in both the open and closed position.

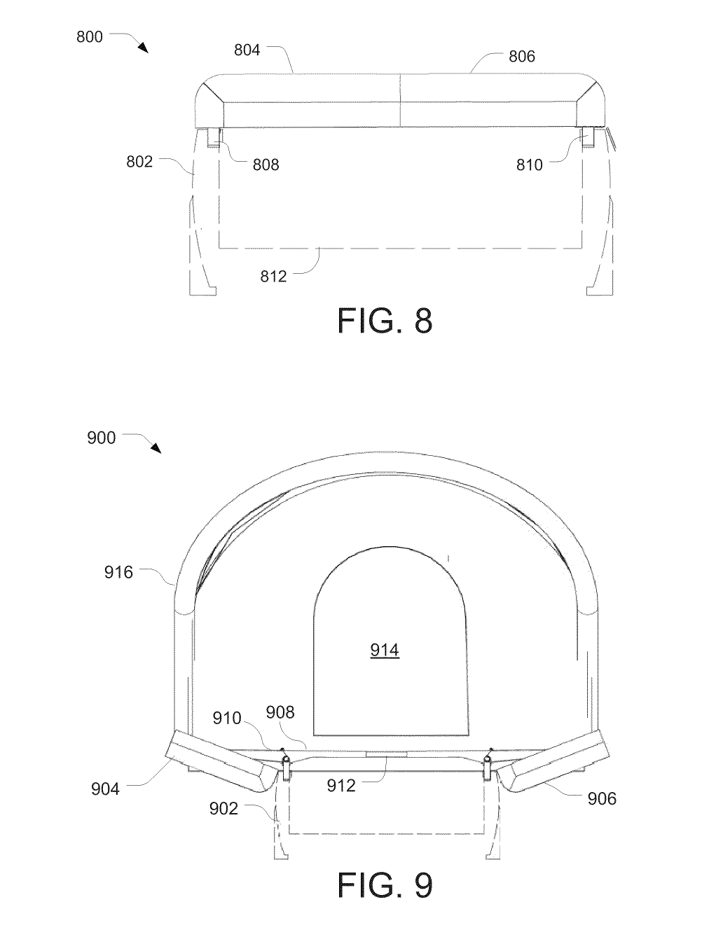

FIG. 8 illustrates a tent camper 800 in the cargo portion of a vehicle 802 in a stowed configuration in accordance with an embodiment of the present invention. Tent camper 800 is mounted in a cargo portion (e.g., in the back of a pickup truck) with mounts 808 and 810. Mounts may be adaptable to a variety of vehicles or may be specific to a particular attachment method or vehicle. Additionally, mounts may comprise straps, hooks, or any mounting hardware known in the art. Tent camper 800 may be configured to rest on the top of the cargo area without detracting from usable storage space underneath. Thus, cargo may be stored on the flatbed portion 812 of the vehicle with the tent camper 800 providing protection from the weather. While in the closed position, wings 804 and 806 are folded against the tent camper 800 to provide for a compact, aerodynamic shape.

FIG. 9 illustrates a tent camper 900 in the cargo portion of a vehicle 902 in an opened configuration in accordance with an embodiment of the present invention. This tent camper 900 corresponds to the tent camper 800 shown in FIG. 8. While in the open position, wings 904 and 906 extend from the central portion of the tent camper to provide a base for a tent 916. A door 914 allows access to the interior of the tent 916.

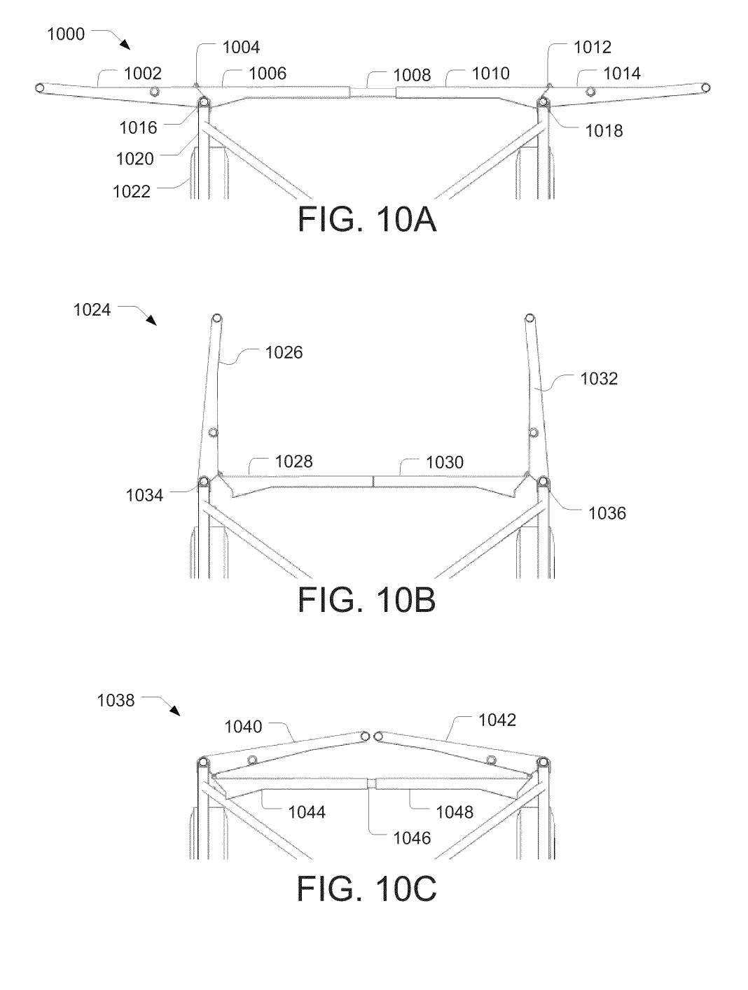

In one embodiment, the opening mechanisms of the tent camper 900 are structurally similar to the opening mechanisms shown in the tent trailer 600. Tent camper 900 includes, but is not limited to, a swingarm 910 connected to a crossbar portion 908. As will be explained in relation to FIGS. 10A-C, the crossbar includes a central portion 912. Tent camper 900 may include any number of crossbars and swingarms similar to the tent camper 600.

In one embodiment, tent 916 may correspond to the tents shown in FIGS. 2-5. Additionally, tent 916 may be configured in any configuration, including but not limited to, a barrel or tunnel configuration, a dome configuration, or a teepee configuration.

FIGS. 10A, 10B, and 10C illustrate various positions of the tent camper including an open position 1000, an intermediate position 1024, and a closed position 1038. The tent camper illustrated in FIGS. 10A-C may correspond to the tent trailers and campers shown in FIGS. 1-9. For ease of explanation, FIGS. 10A-C show a simplified view of the tent trailer and do not include motors, tents, linkage, etc.

FIG. 10A illustrates a detailed view of a tent trailer in an opened configuration 1000 in accordance with an embodiment of the present invention. This view corresponds to a rear view of a tent trailer 600, for example. The tent trailer includes a tire and wheel assembly 1022 and a frame portion 1020. A left swingarm 1002 is mounted to the frame 1020 via a rotatably mounted tube 1016, corresponding to tube support 706 in FIG. 7. Left swingarm 1002 is hingably coupled with a first crossbar portion 1006 via a first hinge 1004. The first crossbar portion 1006 is coupled with a central crossbar portion 1008, which in turn is coupled with a second crossbar portion 1010. As will become clear in relation to FIGS. 10B and 10C, central crossbar portion 1008 provides structural integrity to the crossbar mechanism, while allowing the entire assembly of first portion 1006, central portion 1008, and second portion 1010 to change in length depending on the position of the wings. The central crossbar portion 1008 may be affixed to either the first portion 1006 or the second portion 1010 as long as the range of motion is not restricted. The second crossbar portion 1010 is further hingably coupled with the right swingarm 1014 via a second hinge 1012. The right swingarm 1014 is mounted with the frame with a rotating tube 1018.

As the tent trailer transitions between a closed or open position, the components are moved into intermediate configuration 1024 illustrated in FIG. 10B in accordance with an embodiment of the present invention. Left swingarm 1026 and right swingarm 1032 rotate about the axis of the corresponding tube mounts 1034 and 1036. This rotation directs the first crossbar portion 1028 and the second crossbar portion 1030 inwards and down towards the center of the tent trailer. In this intermediate view 1024, the first and second portions 1028 and 1030 have completely obscured the central crossbar portion 1008 (not shown in FIG. 10B). This configuration allows the tent trailer to maintain structural integrity in the open configuration while still transitioning into a small, aerodynamic package with a low center of gravity in the stowed configuration.

FIG. 10C illustrates a detailed view of a tent trailer in a closed configuration 1038 in accordance with an embodiment of the present invention. Left swingarm 1040 and right swingarm 1042 are in a stowed position, while first crossbar portion 1044 and second crossbar portion 1048 have moved apart and downwards relative to their positions in the intermediate position 1024, revealing the central crossbar portion 1046.

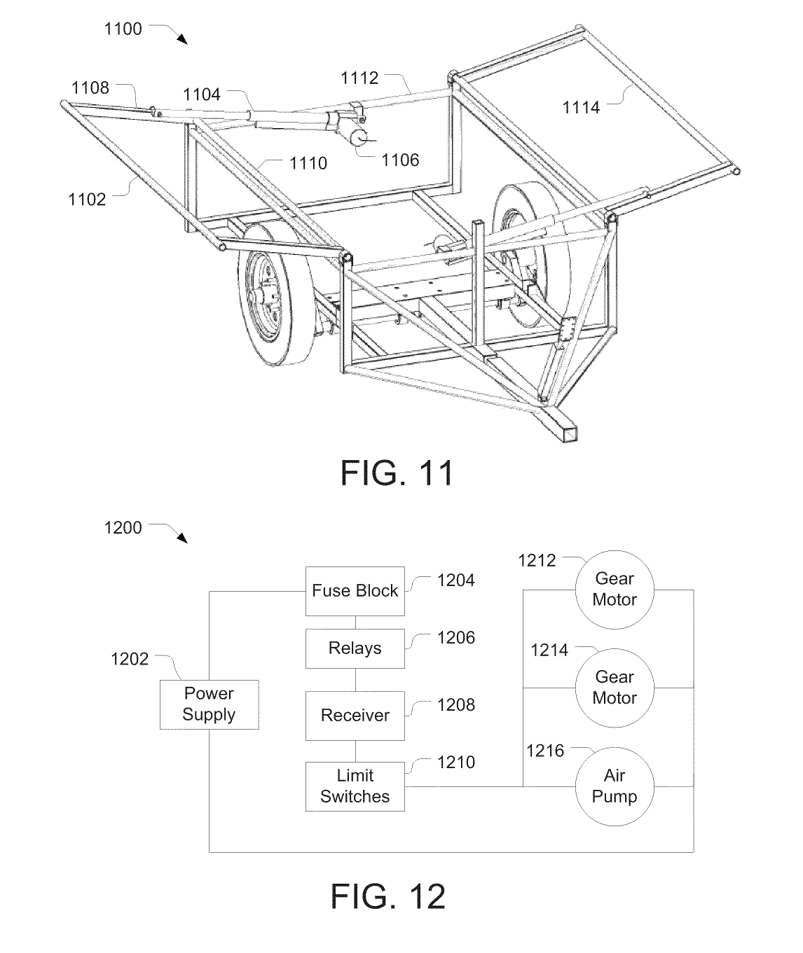

FIG. 11 illustrates an isometric view of an alternate frame configuration 1100 of a tent trailer in accordance with an embodiment of the present invention. Frame configuration 1100 may be used in conjunction with the tarpaulin floor configuration shown in FIG. 14. Motor 1106 is mounted to frame 1112. When activated, motor 1106 extends lateral actuator 1104, driving swingarm 1108 from a closed position to an open position. A corresponding motor, actuator, and wing configuration (unnumbered) may be used for the right wing in FIG. 11. When the wings are in the open position, outer rails 1102 and 1114 become support frames for the tarpaulin foundation (i.e., a tent floor) shown in FIG. 14.

In one embodiment, motor 1106 may include, but is not limited to a gear motor, an electric motor, an actuator, pneumatics, hydraulics, spring-loaded assist. Further, an actuator member may be omitted entirely in a further embodiment. Although not shown, frame 1100 may include any mechanical systems including an inflation member, a remote activation device, etc. and may include a tent with any tent configuration known in the art.

FIG. 12 illustrates block diagram view 1200 of a tent trailer in accordance with an embodiment of the present invention. Any of the tent trailers and campers seen in FIGS. 1-9 and 11 may include the mechanical and electrical devices in the block diagram 1200. These components have been logically grouped in block diagram view 1200 and may be implemented according to any electrical and/or mechanical topology known in the art. Furthermore, an implementation of the block diagram 1200 may omit or add components.

In one embodiment, each tent trailer may include a power supply 1202, which may be any battery or electrical storage device. In another embodiment, the power supply may include an alternator connected to a wheel assembly (e.g., 114) to recharge a battery during travel. The power supply may be in turn connected to a fuse block 1204, a set of relays 1206, a receiver 1208, and limit switches 1210. These components drive gear motors 1212 and 1214 as well as an air pump 1216.

In one embodiment, the receiver 1208 may receive signals from an external remote or key fob activated by the user to control the operation of the tent trailer system. For example, a user may activate the motors 1212 and 1214 to transition the tent trailer from a closed position (e.g., tent trailer 100) to an open position (e.g., tent trailer 200). After or while the trailer is opening, the operation may trigger the air pump to begin inflating an associated inflatable tent. Alternately, the air pump may not begin until directed by the user. The receiver may also control the system to run in reverse, thereby deflating the inflatable tent and stowing the wings of the tent trailer to the closed configuration.

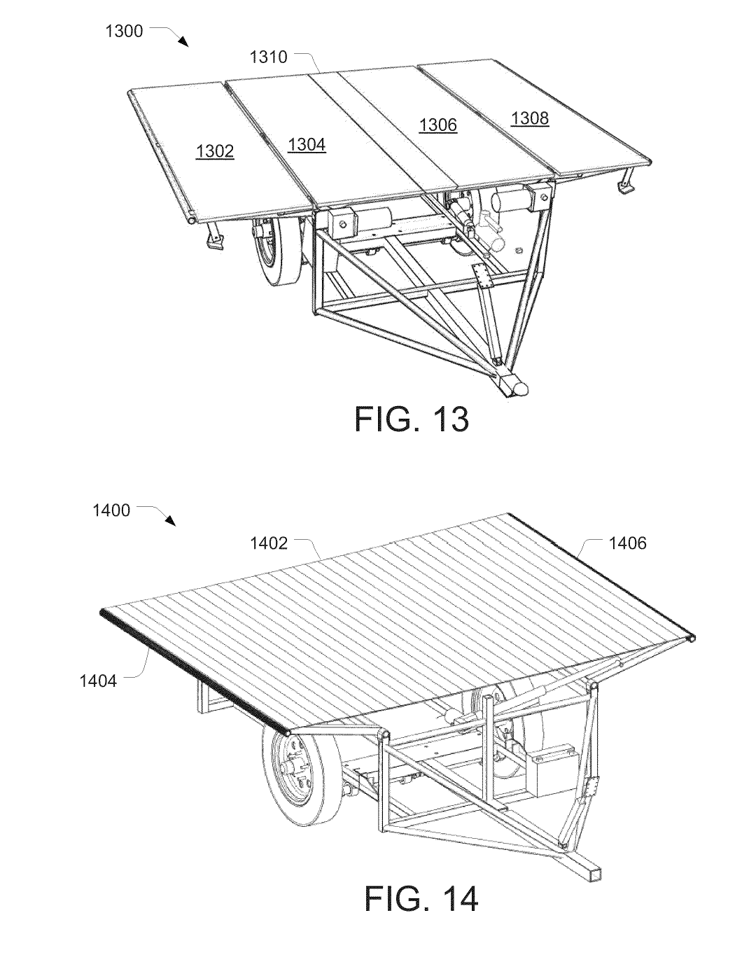

FIG. 13 illustrates an isometric view of a panel floor configuration 1300 in a tent trailer in accordance with an embodiment of the present invention. The panel floor configuration 1300 may be used in conjunction with the crossbar frame 600 shown in FIG. 6. In one embodiment, wing panels 1302 and 1308 are affixed to the movable wings corresponding to the left wing (e.g., comprised of swingarms 602a-c and end rail 608) and the right wing (e.g., comprised of swingarms 606a-c and end rail 610). In one embodiment, central panel 1304 is attached to the first crossbar portion (e.g., first crossbar portion 1006 in FIG. 10A) while central panel 1306 is attached to a second crossbar portion (e.g., second crossbar portion 1010 in FIG. 10A). Because the crossbar portion changes length as the wings move from a closed position to an open position (e.g., as described in relation to FIGS. 10A-C), central panel 1304 overlaps with central panel 1306 in the area indicated by overlap region 1310. Thus, the central portion of the panel floor 1300 provides full support to the tent while the tent trailer is in the open position (e.g., corresponding to FIG. 10A) while stowing easily (e.g., with varying width as seen in FIGS. 10B and 10C) in a closed position.

FIG. 14 illustrates an isometric view of a tarpaulin floor configuration 1400 in a tent trailer in accordance with an embodiment of the present invention. The tarpaulin floor configuration 1400 may be used in conjunction with the tension frame 1100 shown in FIG. 11. In one embodiment, the tarpaulin 1402 is affixed to the end rails 1404 and 1406. These end rails 1404 and 1406 correspond to the end rails 1102 and 1114 in FIG. 11. When the wings are extended to the fully open position, the tarpaulin 1402 is tensioned from edge to edge resulting in a taught but cushioned sleeping foundation for support of a sleeping cover or an air mattress.

While several embodiments of the present invention have been illustrated and described herein, many changes can be made without departing from the spirit and scope of the invention. Accordingly, the scope of the invention is not limited by any disclosed embodiment. Instead, the scope of the invention should be determined from the appended claims that follow.

The embodiments of the invention in which an exclusive property or privilege is claimed are defined as follows:

1. A lightweight tent camper, comprising:
a frame member;
a body member attached to the frame member providing a storage area;
a first swing arm member attached to the frame member with a first hinge member;
a second swing arm member attached to the frame member with a second hinge member;
a first panel attached to the first swing arm member;
a second panel attached to the second swing arm member;
wherein the first panel and the second panel enclose the storage area when the first swing arm member and the second swing arm member are in a first closed position;
at least one actuator member attached to the frame member for rotating the first swing arm and the second swing arm from the first closed position to a second open position; and
a tent attached to the first swing arm member and the second swing arm member.

2. The lightweight tent camper of claim 1, wherein the actuator member automatically rotates the first swing arm member and the second swing arm member from the first closed position to the second open position in response to a remote trigger.

3. The lightweight tent camper of claim 1, wherein the first swing arm member is further hingably coupled to a crossbar member, and
wherein the second swing arm member is further hingably coupled to the crossbar member.

4. The lightweight tent camper of claim 3, wherein the crossbar member comprises:
a first crossbar portion hingably connected to the first swing arm member;
a second crossbar portion hingably connected to the second swing arm member; and
a central crossbar portion slidably coupled with the first crossbar portion and the second crossbar portion.

5. The lightweight tent camper of claim 4, wherein the crossbar member telescopically changes length when the at least one actuator member rotates the first swing arm and the second swing arm from the first closed position to the second open position.

6. The lightweight tent camper of claim 1, wherein the tent further comprises a tarpaulin floor tensioned by the first swing arm member and the second swing arm member.

7. The lightweight tent camper of claim 1, wherein the tent further comprises a paneled floor.

8. The lightweight tent camper of claim 1, wherein the body member comprises an aerodynamic composite shell.

9. The lightweight tent camper of claim 1, wherein the composite shell is constructed of a material selected from the group consisting of carbon graphite molded panels, fiberglass molded panels, and vacuum formed plastic compositions.

10. The lightweight tent camper of claim 1, wherein the frame member further comprises:
at least one axle;
at least one pair of wheel and tire assemblies associated with the at least one axle; and
at least one trailer attachment member for attaching the lightweight tent camper to a towing vehicle.

11. The lightweight tent camper of claim 10, wherein the lightweight tent camper is a trailer capable of being towed by a motorcycle or small car.

12. The lightweight tent camper of claim 1, wherein the tent is an inflatable tent, and wherein the lightweight tent camper further comprises:
an inflation member attached to the frame member for inflating the inflatable tent.

13. The lightweight tent camper of claim 12, wherein the inflation member automatically inflates the inflatable tent while the actuator member is rotating the first swing arm member and the second swing arm member from the first closed position to the second open position in response to a remote trigger.

14. The lightweight tent camper of claim 12, wherein the inflation member is selected from the group consisting of compressed air, a fan blower, and an air compressor.

15. The lightweight tent camper of claim 1, wherein the tent is erected using tent poles.

16. The lightweight tent camper of claim 1, wherein the tent is configured in a tent configuration selected from the group consisting of a dome configuration, barrel configuration, and teepee configuration.

17. The lightweight tent camper of claim 1, wherein the actuator member is selected from the group consisting of an electric motor, an actuator, pneumatics, hydraulics, a gear motor, and a spring-loaded mechanism.

18. The lightweight tent camper of claim 1, wherein the tent camper is adaptable to attach to a cargo portion of a truck.

19. A lightweight tent camper system, comprising:
a frame member;
a body member attached to the frame member providing a storage area;
a first swing arm member attached to the frame member with a first hinge member;
a second swing arm member attached to the frame member with a second hinge member;
a first panel attached to the first swing arm member;
a second panel attached to the second swing arm member;
wherein the first panel and the second panel enclose the storage area when the first swing arm member and the second swing arm member are in a first closed position;
at least one actuator member attached to the frame member for rotating the first swing arm and the second swing arm from the first closed position to a second open position; and
a tent attached to the first swing arm member and the second swing arm member.
